(19) United States
(12) Patent Application Publication
(10) Pub. No.: US 2024/0278192 A1
(43) Pub. Date: Aug. 22, 2024

(54) Porous NiBZY Supports for Hydrogen Separation Membranes

(71) Applicant: W. Grover Coors, Golden, CO (US)

(72) Inventor: W. Grover Coors, Golden, CO (US)

(21) Appl. No.: 18/569,287

(22) PCT Filed: Feb. 10, 2022
(86) PCT No.: PCT/US2022/015925

§ 371 Date: Dec. 12, 2023

Related U.S. Application Data
(60) Provisional application No. 63/217,087, filed on Jun. 30, 2021.

(51) Int. Cl. B01D 71/02; B01D 67/00; B01D 69/12; C01B 3/50

(52) U.S. Cl. CPC B01D 71/0271; B01D 67/00411; B01D 69/12; B01D 71/022; C01B 3/503; C01B 2210/0012

(57) ABSTRACT

A layered device is provided. The device includes a ceramic composite substrate layer and a hydrogen permeable layer. The ceramic composite substrate layer includes a metal oxide phase and ceramic proton conducting oxide phase. The substrate layer is dense upon sintering and has contiguous porosity upon reduction in reducing atmosphere. The hydrogen permeable layer includes a single metal, metal alloys or layers of different metals.

### CROSS-REFERENCE TO RELATED APPLICATIONS AND PRIORITY

This application is related to and claims the benefit of U.S. Prov. App. Ser. No. 63/217,087 filed on Jun. 30, 2021, which is incorporated herein by reference for all purposes.

### BACKGROUND

Low-cost hydrogen is needed for transitioning away from the fossil fuel-based economy and towards the emerging hydrogen economy. Pure hydrogen may be produced by electrolysis of fresh water (or seawater after desalinization), but this method is very energy intensive. Hydrogen may also be produced more efficiently at higher temperatures by electrolysis of steam. Another way to generate hydrogen at scale is to separate hydrogen from a mixture of gases generated by steam reforming and partial oxidation of hydrocarbons in a membrane reactor. The resulting gas could include H₂, CO, CO₂, H₂O, N₂ and low molecular weight hydrocarbons. Hydrogen separation is carried out at industrial scale by partial swing adsorption, but this technology is difficult to down-scale to the levels required for distributed H₂ generation, typically less than 100 kg per hour.

Hydrogen separation membrane reactors, on the other hand, can be operated at any scale from grams to kilograms per minute. Hydrogen separation in membrane reactors may be accomplished either galvanically, by applying a voltage across a protonic ceramic electrolyte membrane, or pressure-driven using metals or mixed proton/electron conductors. In the case of galvanic separation, a proton flux of 1 amp per cm² is equivalent to 0.052 mol H₂/m²s. By comparison, a typical pressure-driven Pd membrane can deliver a hydrogen flux of about 1 mol H₂/m²s, or twenty times more hydrogen per membrane area. Hydrogen separation based on atomic diffusion through thin metal membranes has reached a level of technology maturity where it is possible to build cells and assemble them into systems that demonstrate the feasibility of the technology at scale. Membrane separators so constructed will pave the way toward making pure hydrogen from reformed hydrocarbons more efficiently and less costly than with traditional methods. The produced hydrogen is suitable for use directly in hydrogen fuel cells and will enable the hydrogen economy at large scale.

The flux of hydrogen that permeates through a membrane is inversely proportional to the membrane thickness, so membranes must be as thin as possible, and the substrate onto which the membrane is deposited must be smooth and defect free. Separation of hydrogen from mixed gas streams poses significant technological challenges, however, because some of the gas molecules involved are tiny and diffuse through cracks, pinholes and grain boundaries. This problem is exacerbated as the permeation membranes become thinner and thinner, making the practical aspects of fabricating thin membranes very demanding. The quality of the surface of the support onto which a thin metal hydrogen separation membrane is applied is critical for determining the quality to the film. Solutions to the above-described problems and challenges in the art are desired.

### SUMMARY OF THE INVENTION

In a first embodiment, the present invention provides a layered device having a ceramic composite substrate layer and a hydrogen permeable layer. The ceramic composite layer has a metal oxide phase and ceramic proton conducting oxide phase. The substrate layer is dense upon sintering and has contiguous porosity upon reduction in reducing atmosphere. The hydrogen permeable layer includes a single metal, metal alloys or layers of different metals.

In a second embodiment, the present invention provides a pressure-driven hydrogen separator having: a fuel gas channel comprising a fuel gas containing hydrogen; a product hydrogen reservoir containing product hydrogen, and the layered device described above. The layered device is disposed between and separates the fuel gas channel and the product hydrogen reservoir where the hydrogen permeable layer is disposed facing the fuel gas channel and the ceramic composite substrate layer is disposed facing the product hydrogen reservoir. The partial pressure of hydrogen in the fuel gas channel is greater than the partial pressure of hydrogen in product hydrogen reservoir.

In a third embodiment, the present invention provides a pressure-driven hydrogen separation device having: a layered device comprising a ceramic composite substrate layer comprising a metal oxide phase and ceramic proton conducting oxide phase, wherein the substrate layer is dense upon sintering and has contiguous porosity upon reduction in reducing atmosphere; a fuel gas channel comprising a fuel gas containing hydrogen; and a product hydrogen reservoir containing product hydrogen. The ceramic composite substrate layer is disposed between and separates the fuel gas reservoir and the product hydrogen reservoir. The partial pressure of hydrogen in the fuel gas channel is greater than the partial pressure of hydrogen in product hydrogen reservoir.

In a fourth embodiment, the present invention provides a method for pressure-driven separation of hydrogen including the steps of providing a pressure-driven hydrogen separation device described above, flowing a fuel gas in the fuel gas channel, allowing hydrogen to permeate across the ceramic composite substrate layer and into the product hydrogen reservoir. The partial pressure of hydrogen in the fuel gas channel is greater than the particle pressure of hydrogen in product hydrogen reservoir.

In a fifth embodiment, the present invention provides a method for forming a layered hydrogen separation device including the steps of: forming a ceramic composite substrate layer comprising a metal oxide and ceramic proton conducting oxide, sintering the substrate layer formed in step I, reducing the sintered substrate layer formed in step II in a reducing atmosphere; and depositing a hydrogen diffusion membrane layer over a first surface of the substrate layer, wherein the hydrogen diffusion membrane layer contains a single metal, metal alloys or layers of different metals.

In a sixth embodiment, the present invention provides an arrayed hydrogen separation system, including: a plurality of pressure-driven hydrogen separation devices as described above, a common product hydrogen channel, and a common fuel gas channel. The plurality of devices are disposed in a planar radial array about the common product hydrogen channel. The plurality of devices are each spherical and enclose their respective product hydrogen reservoir which are connected to and in fluid communication with the common hydrogen channel, the common fuel gas channel is common to the plurality of devices. In a further embodiment, the arrayed hydrogen separation system may be stacked axially along the common product hydrogen channel where the common product hydrogen channel and the common fuel gas channel are common to the plurality of arrayed hydrogen separation systems.

### BRIEF DESCRIPTION OF THE DRAWINGS

FIG. 1 shows a cross-section view of a tubular permeation membrane

FIG. 2 shows cut-away cross-section of H₂ diffusion membrane.

FIG. 3 shows an SEI image the fracture surface of reduced NiBZY substrate with electroless plated palladium membrane (FESEM 2000×).

FIG. 4 shows a cross-section view of a spherical bulb with brazed ceramic or metal port.

FIG. 5 shows a cross-section view of a single-piece bulb with integral stem port.

FIG. 6 shows top view of an eight-bulb ring with central H₂ collection manifold.

FIG. 7 shows an SEI image of fracture surface of NiO/BZY20 microstructure at 5000×. (FESEM image).

FIG. 8: shows SEI images of unreduced surface of NiO/BZY composite. 1000× (left) and 5000× (right). The rounded 1 micron BZY grains are typical of surface morphology. Some larger 2.5 recrystallized NiO grains are visible at the surface. (FESEM images).

FIG. 9 shows NiO/BZY reduction curves. Specimen preheated in air to 500° C. prior to application of H₂ (black) and specimen heated to 500° C. in H₂ from room temperature (gray).

FIG. 10 shows a cross-section view of a partially reduced disc after 8 hours at 500° C.

FIG. 11 shows an SEI image of a typical reduced microstructure of Ni/BZY cermet (5000× left). NiO grain reduced to “spongy” morphology (10,000× right).

FIG. 12 shows SEI images of the surface microstructure of reduced NiBZY cermet (5000× left). The penetrating nano-pore structure of the reduced NiO grain is captured in the image on the right and the nanometer Ni particles characteristic of exsolution may be seen decorating the BZY grains (20,000× right).

FIG. 13 shows an SEI image of a side view of reduced NiBZY surface. Estimated surface roughness is 1-3 microns.

### DETAILED DESCRIPTION

The present invention solves problems in the art and provides superior layered devices and pressure-driven membrane reactors/separators and provides methods of forming said devices which are suitable for use in pressure-driven hydrogen separation applications for separating hydrogen from a raw fuel supply. Without being bound by a particular mechanism of action the present invention will be described further in the following description of preferred embodiments.

Hydrogen permeation membranes are the leading technology for separating hydrogen from mixed gas streams because they offer high hydrogen permeation flux and nearly perfect hydrogen separation compared to many other types of separation membranes. Atomic hydrogen permeates through most metals while other gases are rejected. As shown in FIG. 1, to fabricate these membranes 100, thin metal films 101 are deposited on supports 103 consisting of porous ceramic or metal. Since these metal membranes are often less than 5 microns thick (for example between 0.1 and 5 microns thick), their quality and performance depend on the characteristics of the support 103 onto which the metal 101 is deposited. The support 103 is typically a porous ceramic or metal structure with the necessary permeability for gaseous hydrogen to diffuse away from the metal 101 while providing the mechanical strength, endurance, and robustness for supporting the thin metal films 101 and operating conditions. The hydrogen permeation membrane 100 shown in the tubular cross section of FIG. 1 can be made from metals such as palladium (Pd). Hydrogen permeates through the membrane 100 from a hydrogen-containing fuel gas 109 flowing exterior to the membrane 100 while purified product hydrogen is collected in hydrogen reservoir 107.

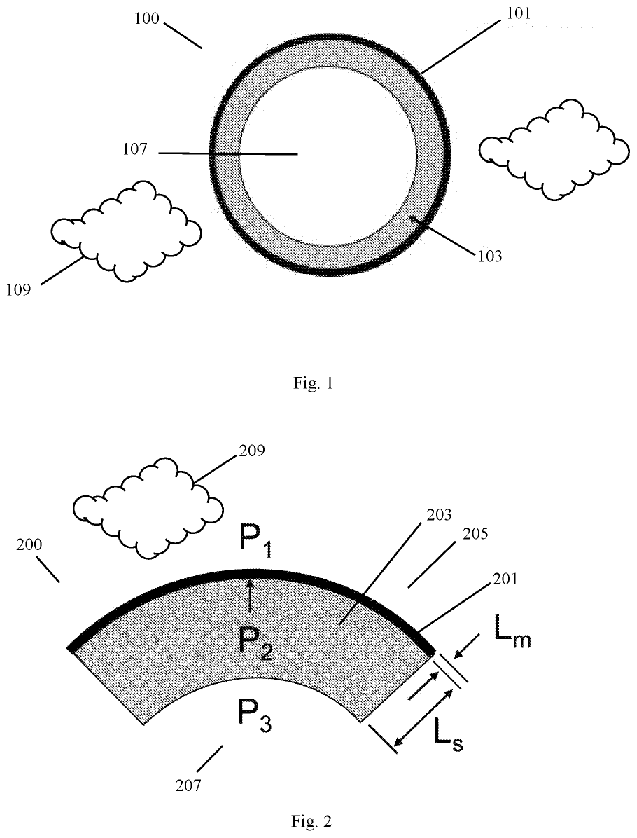

A cross-section of a representative hydrogen diffusion membrane 200 is shown in FIG. 2. A mixture of gasses 209 containing hydrogen plus other gases, that may include CO, CO₂, H₂O, Ar, He, N₂, and low molecular weight hydrocarbons, flows on the outside 205 of the membrane 100 with hydrogen partial pressure, P₁. A metal film 201 of thickness Lₘ is deposited on the exterior surface of the membrane support 203 with wall thickness, Lₛ. Pure hydrogen is formed at the interface between the metal membrane 201 and the porous support 203 at pressure P₂. Purified hydrogen is collected on the inside 207 of the membrane support 203 at pressure P₃. Atomic hydrogen permeates through the metal film 201 and molecular hydrogen diffuses to the inside through a continuous network of interconnected pores in the support 203. FIG. 2 depicts a hydrogen separation membrane 200 as a curved surface perpendicular to the direction of hydrogen flux (in the plane of the page), however any shape where the hydrogen on the inside channel 207 is completely enclosed either by a dense metal membrane or gas-impermeable regions that prevent other gases from diffusing from the outside to the inside constitutes a hydrogen separation membrane 200 [1]. Alternatively, in an embodiment not shown, the metal film may be deposited on the inside in which case, hydrogen diffuses from high pressure on the inside to low pressure on the outside. In other words, P₃>P₁ in this case. In preferred embodiments, the partial pressure of hydrogen in the fuel gas channel is between 1.1 and 50 times greater (for example between 1.5 and 40, between 2 and 30, or between 2 and 20 times greater) than the partial pressure of hydrogen in product hydrogen reservoir, for example wherein the partial pressure of hydrogen pressure of hydrogen in the product hydrogen reservoir is about 1 ATM (or less such as under vacuum) and the partial pressure of hydrogen in fuel gas channel is at least 1.5 ATM (for example 2 ATM, 3 ATM, 5 ATM, 10 ATM or more).

In accordance with another embodiment, the present invention provides a method for pressure-driven separation of hydrogen comprising the steps of: I. providing a layered device and/or a pressure-driven hydrogen separation device as described anywhere herein; II. flowing a fuel gas in the fuel gas channel; III. allowing hydrogen to permeate across the ceramic composite substrate layer and into the product hydrogen reservoir, wherein the partial pressure of hydrogen in the fuel gas channel is greater than the particle pressure of hydrogen in product hydrogen reservoir.

In preferred embodiments, palladium is the metal of choice to be deposited as a diffusion membrane because it has the characteristics of high hydrogen solubility and diffusivity. Since, almost all metals and metal alloys exhibit these characteristics to some extent, other single metals, combination of metals, and/or metal alloys may be used. Nickel, for example, works nearly as well at higher temperatures. Other contemplated metals include zirconium and vanadium which have the potential to permeate even more hydrogen than palladium given the right surface activation to promote molecular hydrogen dissociation. The bulk properties of many different metals and alloys with respect to hydrogen solubility and diffusivity may be found in references such as [2], [3], and [4] and any or all of the described materials may be employed.

Controlling the porosity of the support onto which the metal film is deposited is an important parameter because the metal must bridge any gaps or pores at the surface. If the pores are too small or not interconnected, then hydrogen that permeates through the membrane has difficulty diffusing through the support to the hydrogen collection manifold on the inside of the tube. If the pores are too large, the deposited metal film does not bridge all the pores, leaving pinholes for hydrogen and the other gases to leak through. The allowable defect level for these membranes is on the order of 1 micron-diameter pinhole per square centimeter of surface area to achieve the necessary separation factor. Carbon monoxide, for example, which is a small molecule about the same size as hydrogen, must be held to low ppm levels if the hydrogen produced from these membranes is to be used directly in polymer electrolyte membrane fuel cells (PEMFC) and electrochemical compression devices. This is an extremely challenging requirement that has hindered the commercialization of the technology. A comprehensive review of the technology of hydrogen diffusion membranes may be found in reference [5].

Porous supports can be fabricated from ceramic or metal powders that are partially sintered to some fraction of their full density. These powders have a range of sizes, and the average particle size determines the fired characteristics. But the powders used also have a range of particle sizes, some of which are large enough to produce pores that are too large to bridge by the metal deposition, leaving a pinhole. A common solution to this problem is to deposit a thin layer of very fine particles on the surface, such as gamma alumina or nano-sized zirconia, but this requires additional complex and costly processing steps.

In a preferred embodiment, the present invention provides a layered device (such as a pressure-driven hydrogen separator/reactor) comprising a ceramic composite substrate layer and a hydrogen permeable layer. The substrate layer includes a metal oxide phase and ceramic proton conducting oxide phase and is dense upon sintering and has contiguous porosity upon reduction in reducing atmosphere. The hydrogen permeable layer comprising a single metal, metal alloys or layers of different metals. In a preferred embodiment, wherein the substrate layer and the hydrogen permeable layer lack the presence of electrical connectors such as wires, contact areas, or pad to prevent application of a bias potential between the layers and hence prevent the layered device from being used for galvanic applications etc.

In a most preferred embodiment, the present invention provides a composition useful in forming the ceramic composite substrate layer comprising, consisting of, or consisting essentially of a composite of nickel oxide (NiO) and a perovskite ceramic proton conductor, of sintered composition, AB₍₁₋ₓ₎XₓO_{3-d}, where the A-site consists of Ba or Sr, the B-site consists of Zr and Ce and X is an aliovalent dopant consisting of Y, Yb, Eu, Gd, other rare earth elements or combinations, thereof. Often cerium and zirconium share the B-sites with the formulation nomenclature, BZCYxy, where ‘x’ is the fraction of zirconia and ‘y’ is the fraction of ceria. In a preferred embodiment, the composition is named BZCY62 and has the formula BaZ_{0.6}Ce_{0.2}Y_{0.2}O_{3-d}. A representative composition of this class containing no cerium is BaZr_{0.8}Y_{0.2}O_{3-d} (BZY20). In this case, the nomenclature indicates barium zirconate with 20 mole percent yttrium substituted on B-sites. Further information regarding the ceramic proton conducting phase and the stoichiometric variants can be found in reference [6].

When this composite ceramic composition is sintered from precursor powders, it becomes completely densified due to the mechanism called solid-state reactive sintering (SSRS). Related ceramic composites are used in galvanic protonic ceramic devices for electrodes that are exposed to reducing atmosphere but have not been applied in pressure-driven hydrogen separation applications for which they have been unexpectedly found to be particularly well suited. Upon reduction, the NiO converts to metallic nickel, forming a network of interconnected metallic particles with the associated interconnected porosity of about 25 vol % that results from steric reduction in size in going from nickel oxide to nickel metal. The BZY phase provides the mechanical skeleton and dimensional stability for the structure. The porosity and pore structure of the reduced ceramic composite is ideal for hydrogen separation membrane supports because hydrogen gas diffuses through the interconnected pores. The passage of hydrogen through the metal membrane is the result of a differential in hydrogen partial pressure based on Sievert's Law. High pressure on the upstream side of the membrane drives a flux of hydrogen atoms through the membrane to the low-pressure side. Atomic hydrogen that emerges from the metal at the interface between the membrane and the porous support combines to form diatomic hydrogen gas, which diffuses through the pores of the support.

What is unique about the NiO-BZY composite is that the ceramic matrix is almost completely dense in the as-sintered state. High density upon sintering means that the sintered ceramic body has achieved some percentage close to that of the theoretical density of the ceramic phases that would exist without any open space, typically greater than 95%. In some embodiments, during manufacture, the physical state of the substrate layer (in the layered device, reactors, and/or separations) may be selected from the group consisting of: sintered and unreduced; sintered and partially reduced thereby having some surface porosity but no contiguous porosity throughout the substrate; sintered and fully reduced thereby having contiguous percolating porosity throughout the substrate from the first surface to the second surface.

Porosity is subsequently introduced by reduction of the NiO phase to metallic nickel which may be controlled by the reduction time and temperature. Typically, twenty-four hours at 500° C. in reducing atmosphere is sufficient to fully reduce a support substrate of 1-2 millimeters in thickness, resulting in a network of interconnected gas channels on the order of 100 nanometers, which is ideal for allowing hydrogen gas to diffuse away from the permeation membrane. Sintered bodies exhibit two types of porosity; open and closed. Closed porosity occurs when an internal pore does not communicate with the surroundings. Such pores are not particularly useful for diffusing hydrogen. Open porosity means that a pore is in communication with at least some portion of the surroundings. Contiguous open porosity throughout the entire substrate is required for hydrogen to diffuse from the interface of the membrane and the porous support to the hydrogen collection manifold. In the language of metal/ceramic composites, this type of porosity is often called “percolating”. Percolating (or contiguous) porosity is a necessary condition for hydrogen (or any gas) diffusion.

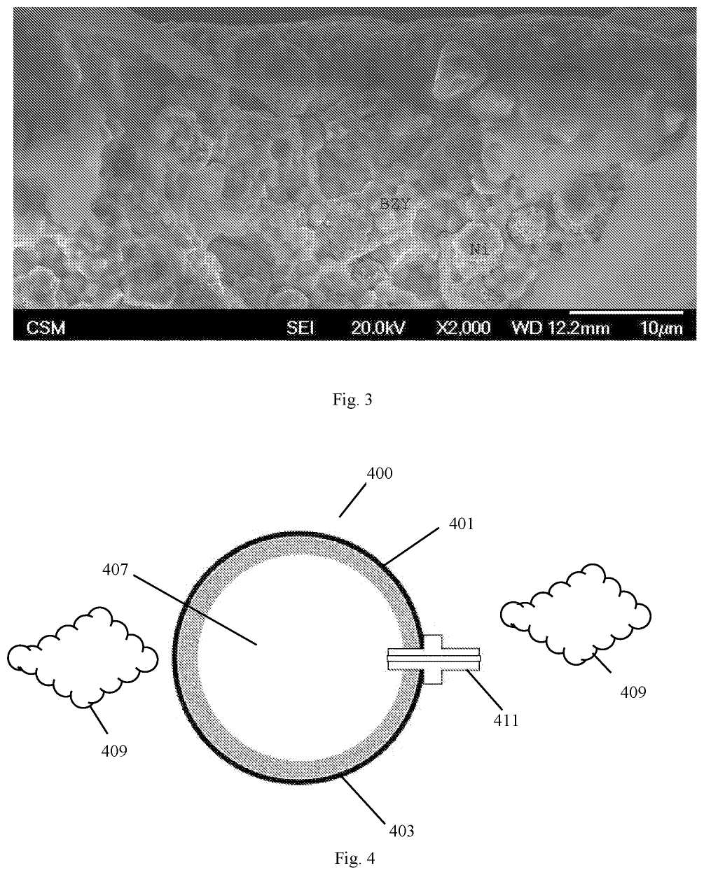

The properties of the surface onto which the metal film is deposited may be tailored to the required surface roughness required to obtain a continuous, defect-free coating. Ideally, the metal of the membrane is deposited on a reduced substrate, but the metal film may also be deposited on an unreduced or partially reduced substrate since the surface morphology is changed very little during reduction. This method of separator/reactor formation is a novel approach which has not been reported in the art. The resulting thin metal films deposited on NiO/BZY substates enables fabrication of high flux and high reliability pressure-driven hydrogen separation membranes. FIG. 3 shows the fracture surface of a palladium film deposited by electroless plating onto a fully reduced Ni-BZY substrate. The 5 micron palladium membrane is shown well-adhered to the composite substrate consisting of porous nickel particles and clusters of BZY crystallites.

With the advent of SSRS it is feasible to manufacture ceramic composites of NiO and BZY. Yttrium-doped barium zirconate is the preferred ceramic proton conductor for galvanic protonic ceramic devices such as fuel cells (PCFCs), electrolyzers (PCECs) and membrane reactors (PMRs). Due to its intrinsic chemical stability in moist reducing atmosphere containing CO and CO₂, BaZr_{0.8}Y_{0.2}O_{3-d}, with 20 mol % yttrium, BZY20, has emerged as the preferred ceramic proton conductor. In typical electrochemical devices, BZY20 is the ceramic electrolyte used to fabricate the dense hydrogen separation membrane. For pressure-driven devices using metal membranes, however, the protonic ceramic membrane is not required. The protonic ceramic phase in the Ni-BZY20 cermet support provides the mechanical skeleton of the support and the conduction pathways for proton and steam transport required after sintering to reduce the NiO in situ to Ni metal. Additionally, BZY20 may be used for structural components, such as the interconnecting ports shown in FIG. 4, where structural mechanical properties, such as matched thermal expansion, are import.

Fabrication of NiO/BZY20 by SSRS requires preparing ceramic in the “green”, or unfired state from precursor powders of NiO, BaCO₃, ZrO₂, and Y₂O₃. Organic binders are incorporated into the powders to be formed into the desired shape for handling. One of the advantages of SSRS is that solid-state reaction and densification occur simultaneously during sintering, so that high packing density of the ceramic powders in the green state is not a requirement. This permits the use of greater organic binder content and opens the way to using novel fabrication methods not generally suitable for many other types of advanced ceramic materials. Any number of ceramic fabrication techniques, such as slip casting, extrusion, dry-pressing, and injection molding may be employed to produce the desired structure of the spheres depicted in FIG. 3. Molding from polymer clay is one such method and was introduced in ref. [8]. Polymer clay is a good way to fabricate complex shapes by the common techniques of molding, jiggering and extrusion. Such techniques are required for fabricating these types of devices in large-scale manufacturing. Polymer clay is a particularly good way to mold spherical supports, and the process lends itself to automation, as many pottery items such as dishes and bowls are produced in very high volume from clay bodies.

In view of the above, in a further embodiment, the present invention provides a method for forming a layered hydrogen separation device comprising: I. forming a ceramic composite substrate layer comprising a metal oxide and ceramic proton conducting oxide; II. sintering the substrate layer formed in step I; III. reducing the sintered substrate layer formed in step II in a reducing atmosphere; and IV. depositing a hydrogen diffusion membrane layer over a first surface of the substrate layer, wherein the hydrogen diffusion membrane layer contains a single metal, metal alloys or layers of different metals. After performance of step I, the order of steps II, III and IV are preferably performed in order however it is noted that these subsequent steps might be performed out of order. For example, Step IV may be performed prior to step III etc.

Membrane reactors can be fabricated using planar or tubular structures. Each type of architecture has its pros and cons, but neither offers a totally satisfactory solution. In planar devices gas flow channels must be hermetically sealed along their entire perimeter internal to the device. Sealing the ends of tubes is more straightforward, but other architectures for constructing the gas flow channels including tubular coils, spirals and helixes are attractive because they offer higher surface area to volume aspect ratios.

In preferred embodiments, as shown in FIGS. 4-6, the membrane reactor/separator is spherical in shape. Specifically referring to FIG. 4, a membrane reactor 400 having spherical shape has been found to overcome the observed shortcomings of both planar and tubular device architectures of the art. In the present embodiment, hollow spheres, constituting an inner porous support 403 are coated with a thin dense membrane 401 of metal. During operation, the outer surface of the reactor/separator 400 is in contact with the hydrogen-containing mixed fuel gas stream/channel 409 at high pressure. Pure hydrogen permeates through the metal 401 and support 403 to the interior cavity 407 (e.g. the product hydrogen reservoir or channel 407) of the reactor/separator 400. A small port 411 (e.g. ceramic port 411) penetrates the reactor/separator into the product hydrogen reservoir or channel 407) and allows purified hydrogen to flow out of the interior 407 of the reactor/separator to a hydrogen collection manifold (e.g. a common product hydrogen reservoir or channel) for later use, compression, and/or storage.

In other embodiments, a plurality of spherical reactors/separators may be strung together like a string of pearls or a cluster of grapes providing a continuous common hydrogen collection reservoir/channel with series or parallel connections between the connected devices. In some embodiments, at least one device having a single port 411, 511 of the configurations shown in FIGS. 4 and/or 5 starts and/or ends the chain or cluster of reactors/separators and intermediate devices can have two or more ports for interconnection and hydrogen flow with other connected separators/reactors (e.g. the common hydrogen collection reservoir and/or ultimate product hydrogen compression and/or storage).

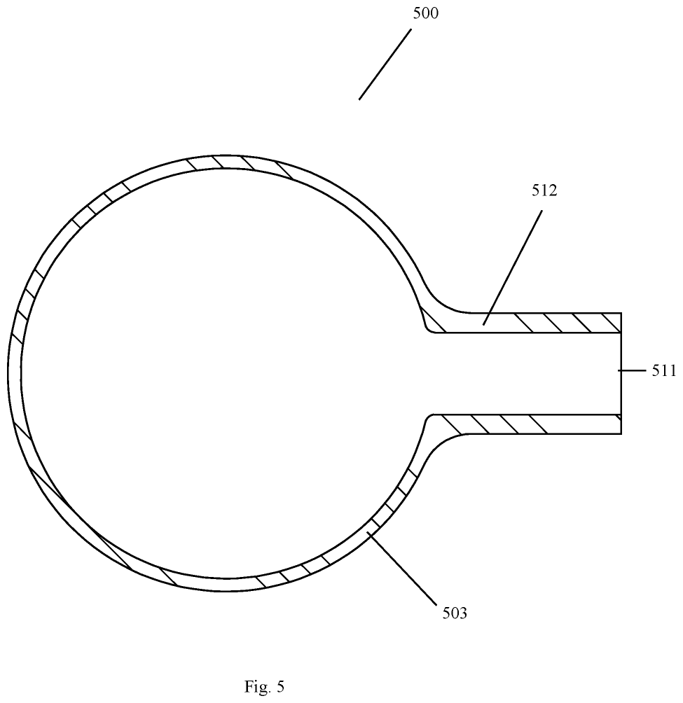

A schematic of a single spherical reactor/separator is depicted in FIG. 4. In another embodiment, a spherical ceramic substrate coated with metal by electroless plating on a 1 mm porous support is depicted in FIG. 5. FIG. 4 shows the ceramic port 411 as a separate element, while the stem 512 and port 511 in FIG. 5 are integral to the ceramic sphere substrate 503. Since the stem 512 constituting the port 511 has the same porosity as the ceramic substrate, the outside surface of stem 512 may be coated with glaze to prevent hydrogen from leaking around the seal that is required to prevent mixed gases on the exterior from leaking into the port 511 and the common product hydrogen reservoir and vice versa.

The ratio of surface area to volume per unit length is the same for a sphere as it is for a cylinder with the same diameter. Accordingly, it may seem that spherical cells bring little benefit over tubular cells. However, to the contrary, the spherical shape of reactor/separator has been found to provide a durable and robust device with superior properties to other types of devices. Tubes must be sealed at both ends while the spherical reactor shown and described herein has a single small diameter port, making this architecture more robust in high shock and vibration environments.

Furthermore, the hydrogen flux of a cell depends on the hydrogen pressure differential from the outside of the cell to the inside. Assuming that the hydrogen pressure on the inside is uniform throughout the system, in order to maximize the fraction of hydrogen recovered from the inlet of the reactor to the outlet, it is necessary to adjust the outside pressure as the partial pressure of hydrogen decreases along the flow channel. It is desirable to slip as little hydrogen as possible in the exhaust. Spherical cells are ideal for this as the stress applied to the exterior of the bulb due to the high external pressures involved are distributed uniformly in the radial direction. This makes it possible to reduce the wall thickness of the support without compromising mechanical strength. Although the figures and corresponding description thereof refer to and depict spherical cells, any enclosed ellipsoid may be employed.

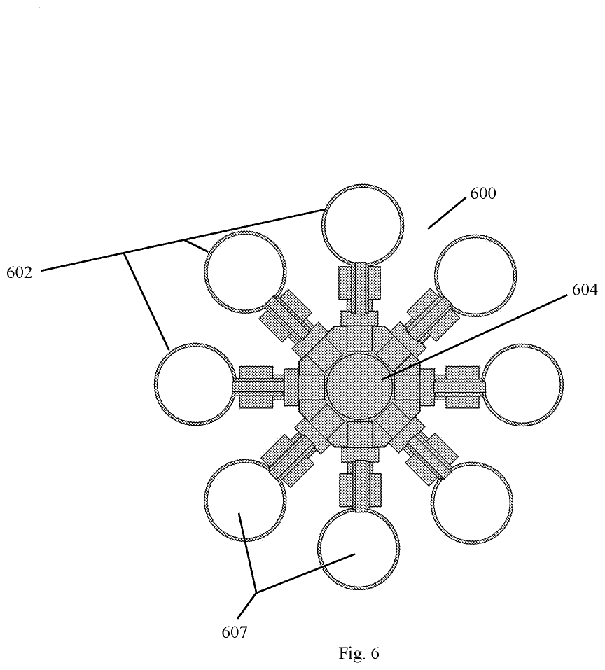

In a further preferred embodiment as shown in FIG. 6, the present invention provides an arrayed reactor/separation system 600. System 600 includes a plurality of spherical reactors/separators 602 as described herein disposed in a radial array (for example a symmetrical and/or planar radial array) about a common product hydrogen channel 604 (e.g. hydrogen collection manifold 604). Fuel gas flows freely in a common fuel gas channel disposed between and external to the plurality of reactors/separators 602. The plurality of reactors/separators 602 are each spherical and enclose their respective product hydrogen reservoir 607 which are connected to and in fluid communication with the common hydrogen channel 604. The common fuel gas channel 607 is common to the plurality of reactors/separators 602. In a further embodiment, this reactor system can be scaled into a larger stacked arrayed hydrogen system by simply stacking (e.g. stacking additional arrayed reactor systems axially on top of each other about the common product hydrogen channel and connecting any new hydrogen collection channel to existing hydrogen collection channel. In this embodiment, the common product hydrogen channels of each individual system and the common fuel gas channel are common to all of the plurality of arrayed hydrogen reactor/separation systems. In this reactor system embodiment, each layer of the stack can optionally be rotated about the central axis (e.g the common product hydrogen channel) so that the spherical reactors of one layer nest more compactly with spherical reactors of adjacent layers while still providing fuel flow and contact with the common fuel gas channel so as to reduce the overall height dimension of the stacked reactor system. For example, the respective layers can be rotated about the common hydrogen channels so that, in a top down view made along the central axis of the system (e.g. along the common hydrogen channel), the spherical reactors of one layer are rotated and/or offset by about ½ to 1.5 times the diameter of a spheric reactor.

### EXAMPLES

Having described the invention in detail, the following examples are provided. The example should not be considered as limiting the scope of the invention, but merely as illustrative and representative thereof.

As described herein, the quality of the surface of the support onto which a thin metal hydrogen separation membrane is applied is critical for determining the quality to the film. After reduction, the support becomes porous permitting the transport of molecular hydrogen away from the interface. Finally, this entire assembly must be mechanically strong in order to provide the meso-structure that is compatible with the temperatures, gas environment and mechanical loads imposed by cell operation.

In the present example, the ceramic support is composed of a mixture of NiO and BZY20 phases in the ratio of 65 wt % NiO and 35 wt % BZY20. If necessary, a thin film of BZY20 and/or NiO may be applied to the surface prior to sintering to enhance metal film deposition. Prior to metal deposition, the cell is exposed to reducing atmosphere at elevated temperatures to reduce the NiO to nickel metal in order to produce a ceramic-metal, or cermet, that is porous. The porosity arises from the volume reduction that occurs when NiO is reduced to metallic nickel, the volume of nickel being about 60% that of NiO. A composite ceramic consisting of 65 wt % NiO (density 6.67 g/cm³) and 35 wt % BZY20 (density 6.06 g/cm³) has a volume fraction of 62.8% NiO and 37.2% BZY20. After reduction, the volume fraction becomes 37.1% Ni, 37.2% BZY20 and 25.7% open porosity. The volume fractions of Ni and BZY20 are about the same and the porosity is sufficient to allow hydrogen to diffuse to the inside and on to the collection manifold. It is possible to increase the reduced porosity by increasing the ratio of NiO to BZY in the formulation.

The extent of porosity may be determined by measuring the weight before and after reduction. The number of moles of NiO in the substrate is the weight times 0.65 divided by the molecular weight, 74.71 g/mol. A completely reduced substrate will lose this many moles of oxygen weighing 16 g/mol. The ratio of the measured reduced weight to this theoretical value times 100 gives the percent reduction.

The cermet body is prepared by blending powders according to the batching worksheet in Table 1. BZY20 is synthesized by solid-state reactive sintering from precursor powders to give the correct stoichiometry. On a per-mole basis, one mole of BaCO₃ (Alfa Aesar #14341), 0.8 mole of ZrO₂ (Alfa Aesar #11395) and 0.1 mole of Y₂O₃ (Alfa Aesar #11180) are prepared by weight. This powder weighs 1.157 times more than the equivalent weight of BZY20 after solid-state reaction, and the batch weight has been adjusted accordingly in the batching formulation. The combined weight of these precursors in a 200-gram batch is 81.0 grams to give 70 grams of BZY20 in the sintered ceramic. Larger batches may be prepared by scaling the ingredients.

TABLE 1
Batching worksheet for 200 grams of
65/35 weigh percent electrode cermet.
Batching worksheet

| | | |
|---|---|---|
| Batch #10 | wt % NiO = | 65.0% |
| Dec. 20, 2020 | wt % BZY20 = | 35.0% |

| | moles/FU | at. wt. | g/mol |
|---|---|---|---|
| Ba | 1.00 | 137.327 | 137.327 |
| Zr | 0.80 | 91.224 | 72.979 |
| Y | 0.20 | 88.906 | 17.781 |
| O | 2.95 | 15.999 | 47.197 |
| | | | 275.284 |

BATCH FORMULATION from precursors

| | | |
|---|---|---|
| Batch size: | 200.00 | grams |
| g NiO | 130.00 | |
| g BZY20 | 70.00 | |
| mol BZY20 | 0.25 | |

| | | | | BATCH |
|---|---|---|---|---|
| | | | g/mol | grams |
| | moles/FU | mol/mol | form. wt. | Powder wt. |
| BaCO3 | 1.00 | 1 | 197.35 | 50.18 |
| ZrO2 | 0.80 | 1 | 123.22 | 25.07 |
| Y2O3 | 0.20 | 2 | 225.81 | 5.74 |
| | | | | 80.99 |
| NiO | 130.00 | | | |

### Sintering:

The parts are sintered dense by solid-state reactive sintering at 1550° C. by the schedule in Table 2. A long burn-out cycle of 31 hours is required to remove all binders.

TABLE 2
Sintering schedule for NiO/BZY polymer clay.

| | | Time to | Duration |
|---|---|---|---|
| Segment | Temp | next (min) | (accum. hrs) |
| 1 | 50 | 180 | 3 |
| 2 | 200 | 1200 | 20 |
| 3 | 600 | 360 | 6 |
| 4 | 1550 | 360 | 6 |
| 5 | 1550 | 360 | 6 |
| 6 | 50 | end | 41 |

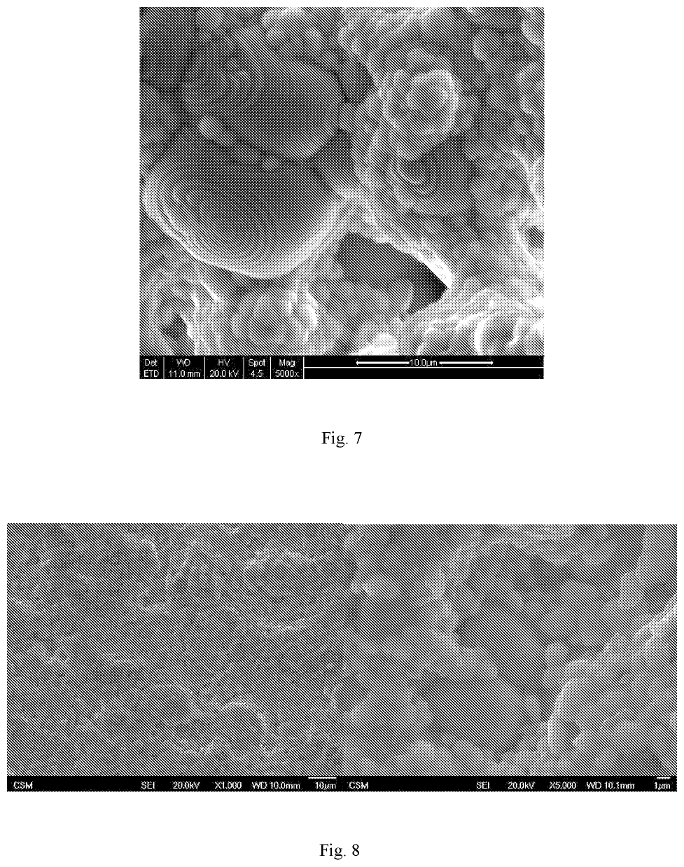

A SEM micrograph of as-fired ceramic prepared by SSRS is shown in FIG. 7. The large faceted 10 micron grains are NiO and the clusters of small 1 micron grains are BZY20. It may be observed from the microstructure that all the grains have grown together during sintering, leaving no residual open porosity. The facetted NiO grains are the hallmark of solid-state reactive sintering. This surface morphology results from the recrystallization of NiO from the liquid phase. Unlike with ordinary sintering of ceramics, a liquid phase of the binary glass, BaO—NiO, forms during sintering. As sintering progresses, the NiO phase solidifies as the BaO reacts with ZrO₂ and Y₂O₃ to form the BaZr_{0.8}Y_{0.2}O_{3-d} phase. Grains form in-situ, filling the volume without the occurrence of dihedral pores at grain boundaries, which is characteristic of ordinary powder sintering. The dense microstructure shown in FIG. 6 does not appear when BZY20 is pre-calcined prior to sintering because no glass phase is involved. The dense microstructure is only obtained by reactive liquid-phase sintering. Some closed voids occur, as can be seen in the figure. These closed voids are characteristic of liquid-phase sintering where the liquid components convert to solid components during solid state reaction and contribute to the open porosity after reduction.

Discs, two cm in diameter by 1.5 mm thick, of NiO/BZY20 composite were prepared using polymer clay and formed in silicone molds in order to characterize the surface morphology for palladium deposition. The sintered Micrographs of the as-fired surface of unreduced NiO/BZY are shown in FIG. 8.

The as-fired surface roughness is about 1-3 microns, suitable for Pd deposition. More importantly, no open pores appear at the surface that would be difficult to bridge during electroless plating.

### Reduction:

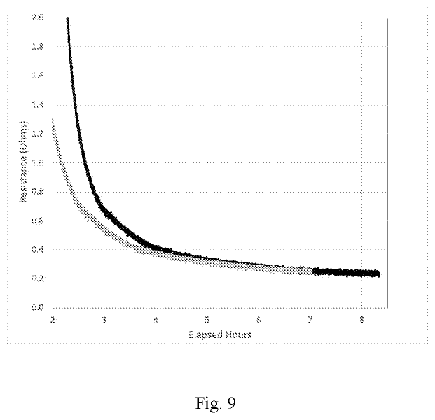

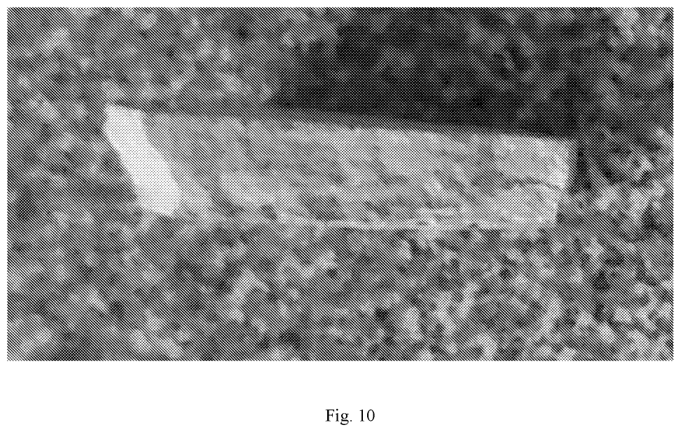

For reduction studies, a sintered disc was cut in half. One half was heated in a quartz tube furnace to 500° C. in air at 8° C./min prior to switching to flowing hydrogen (50 sccm 5% H₂-bal Ar) to begin the reduction process. The resistance of the specimen was recorded continuously for 8 hrs (CompactStat AC Detection at 1 Hz). In a subsequent test, the second half of the disc was heated in flowing hydrogen (50 sccm 5% H₂-bal Ar) from room temperature to 500° C. at 8° C./min. The resistance curves, which show the extent of reduction for the two specimens beginning after 2 hours are shown in FIG. 9. The specimen heated in hydrogen (gray curve) had a head-start, with reduction having already proceeded considerably by the time the specimen reached 500° C. The specimen heated in air (black curve) only began to reduce once the specimen reached the operating temperature of 500° C. However, it is seen that after 4 hours practically no difference in the extent of reduction may be observed, and both curves converge to the same terminal resistivity of about 200 milliohms, characteristic of electronically percolating metallic nickel. The reduction process involves changes in resistance from several megaohms to a fraction of an ohm−a decrease of some eight orders of magnitude is a dramatic effect. Only the final order of magnitude change is shown in the figure. Even though electronic conductivity in the support is not required for pressure-driven membranes, the resistance measurement provides evidence that the open porosity created by NiO reduction is also percolating. This is a necessary requirement for these membrane supports or the hydrogen that permeates through the dense membrane cannot flow out to the collection channel.

The specimens were fractured after 8 hours to determine the depth of penetration of the reduction front. It may be seen in the photograph of FIG. 10 that the reduction to nickel metal was only partial, extending about 20% from the surface into the interior, where unreduced NiO is visible. After 24 hours the extent of reduction, as determined by weight loss, was 97%. The photo confirms that reduction, and the subsequent diffusion of water vapor resulting from NiO reduction, takes place inwardly from the outside surface. This has important implications if the metal membrane is deposited prior to substrate reduction, because metals will be a diffusion barrier to H₂O transport and may retard the reduction process.

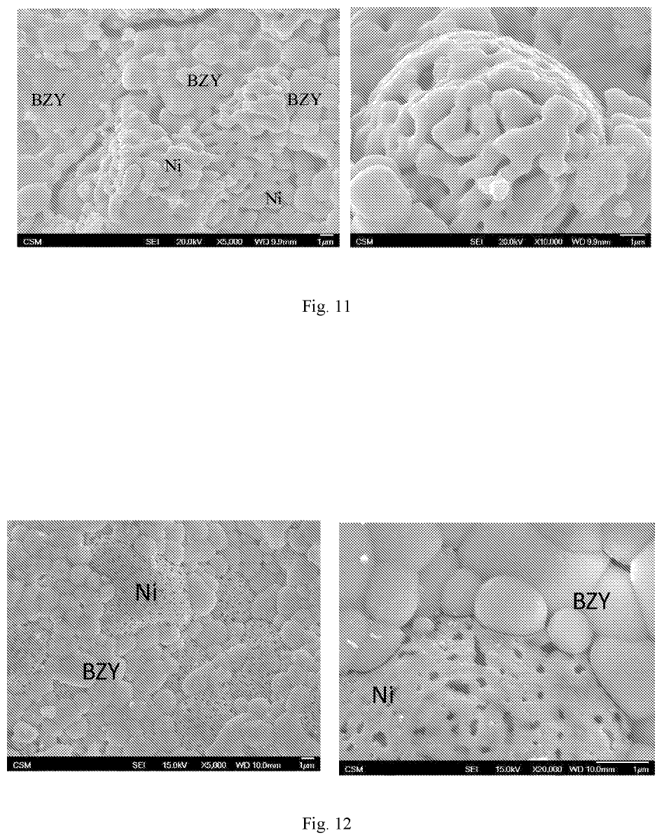

FIG. 11 shows the typical microstructure of a fracture surface of fully reduced Ni/BZY cermet. The BZY crystallites manifest blocky cleavage and the Ni grains take on a “spongy” morphology with a network of submicron pores.

FIG. 12 shows the surface microstructure of a reduced Ni/BZY substrate. The surface is characterized by dense regions of BZY interlocked with nano-porous nickel grains. The microstructure is well suited for electroless plating of metal films.

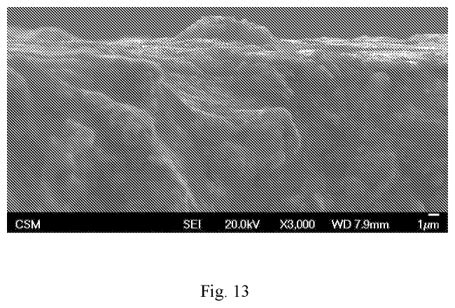

FIG. 13 shows the surface as viewed from the edge of the fracture. The estimated surface roughness is 1 to 3 microns, so a 5 to 10 microns thick metal film should cover the surface imperfections.

### CONCLUSION

It has herein been found and shown that a Ni—NiO/BZY substrate with the unique porosity and morphology, fabricated by solid-state reactive sintering, is suitable for deposition of thin metal films which in turn form hydrogen separators/reactors that are particularly well suited for use in pressure-driven hydrogen separations applications. The deposition of fully dense and defect-free metal films of 1 to 10 microns (e.g. 2-10 microns, 5-10 microns, for example 5, 6, 7, 8, 9, or 10 microns) is possible.

While related compositions have been contemplated for use in electrode supports for galvanic cells, the presently described composition and methods have not before been described or suggested for use in non-galvanic membranes such as in pressure-driven hydrogen separation membrane applications. The unique characteristics of the substrate, which is fully dense upon sintering and which only becomes porous upon reduction makes it possible to tailor surface properties and morphology to optimize deposition of thin metal films. The surface finish of the substrate and the extent of reduction from no reduction at all, to a few monolayers of nickel metal to complete reduction prior to metal deposition may be practiced.

SSRS is a robust ceramic fabrication method that can be accomplished by traditional (and non-traditional) forming methods including isostatic and uniaxial powder compaction, slip casting, injection molding, 3-D printing and molding from clay bodies. A method for forming ceramic bodies from polymer clay is described in Ref. [8].

### Additional Definitions

As used herein, the phrase “dense upon sintering” in connection with some embodiments can be understood in accordance with the following description. The phrase “dense upon sintering” in preferred embodiments means the sintered ceramic body has density that is some fraction of the theoretical density of the ceramic phases that would exist without any open space. Here, this measure is preferably greater than 95%. A textbook definition from Reed [7]: “The bulk density of a particle system is the mass per unit volume of the particles and interstices. The density of a particle is the mass/volume ratio of the particle. In a system of particles, the particle density refers to the mean density of all the different size particles . . . . The density calculated from the chemical formula weight and the volume of the unit cell is termed the x-ray density.”

As used herein, the phrase “contiguous porosity” in connection with some embodiments can be understood in accordance with the following description. Sintered bodies exhibit two types of porosity; open and closed. Closed porosity occurs when an internal pore does not communicate with the surroundings. (Such pores are useless for diffusing hydrogen.) Open porosity means that a pore is in communication with at least some portion of the surroundings. Contiguous open porosity throughout the entire substrate is required for hydrogen to diffuse from the membrane to the exterior. In the language of metal/ceramic composites, this type of porosity is often called “percolating”. Percolating (or contiguous) porosity is a necessary condition for hydrogen (or any gas) diffusion or permeability.

Reference throughout the specification to “one embodiment,” “another embodiment,” “an embodiment,” “some embodiments,” and so forth, means that a particular element (e.g., feature, structure, property, and/or characteristic) described in connection with the embodiment is included in at least one embodiment described herein, and may or may not be present in other embodiments. In addition, it is to be understood that the described element(s) may be combined in any suitable manner in the various embodiments.

Numerical values in the specification and claims of this application reflect average values for a composition. Furthermore, unless indicated to the contrary, the numerical values should be understood to include numerical values which are the same when reduced to the same number of significant figures and numerical values which differ from the stated value by less than the experimental error of conventional measurement technique of the type described in the present application to determine the value.

### REFERENCES

The following references are incorporated herein for all purposes.
[1] Richard W. Baker, Membrane Technology and Applications, 3rd Ed. John Wiley & Sons, Ltd., Publication, 2012 ISBN: 9780470743720, p. 134-136
[2] H. Wipf, “Solubility and Diffusion of Hydrogen in Pure Metals and Alloys,” Physica Scripta T94, 43-51, 2001
[3] Yuh Fukai, “The Metal-Hydrogen System—Basic Bulk Properties” Springer Series in Materials Science, Springer-Verlag, Heidelberg, 1993.
[4] N. A. Galaktionowa, “Hydrogen—Metal Systems Databook,” Ordentlich Publishers, Israel, 1981.
[5] David Alique, David Martinez-Diaz, Raul Sanz and Jose A. Calles *, “Review of Supported Pd-Based Membranes Preparation by Electroless Plating for Ultra-Pure Hydrogen Production,” Membranes 2018, 8, 5; doi:10.3390/membranes8010005
[6] W. Grover Coors and T. Manerbino, “Characterization of composite cermet with 68 wt. % NiO and BaCe0.2Zr0.6Y0.2O3-d,” J. Membrane Sci., 376, 50-55 (2011)
[7] James S. Reed, Principles of Ceramic Processing, 2nd Ed., John Wiley & Sons, Inc., 1995, p. 119.
[8] Sandrine Ricote, Benjamin Kee, W. Grover Coors, “Channelized Substrates Made from BaZr0.75Ce0.05Y0.2O3-d Proton-Conducting Ceramic Polymer Clay,” Membranes 2019, 9, 130; DOI:10.3390/membranes9100130

1. A layered device comprising:
a ceramic composite substrate layer comprising a metal oxide phase and ceramic proton conducting oxide phase, wherein the substrate layer is dense upon sintering and has contiguous porosity upon reduction in reducing atmosphere, and
a hydrogen permeable layer comprising a single metal, metal alloys or layers of different metals.

2. The device of claim 1, wherein the state of the substrate layer is selected from the group consisting of: sintered and unreduced; sintered and partially reduced thereby having some surface porosity but no contiguous porosity throughout the substrate; sintered and fully reduced thereby having contiguous percolating porosity throughout the substrate from the first surface to the second surface.

3. The device of claim 1, wherein the ceramic proton conducting substrate layer comprises a perovskite ceramic proton conductor having the general composition:
AB₍₁₋ₓ₎XₓO_{3-d},
wherein the A-site comprises Ba or Sr, the B-site comprises Zr and/or Ce and X comprises an aliovalent dopant cation consisting of Y, Yb, Eu, Gd, other rare earth elements or combinations thereof.

4. The device of claim 1, wherein the metal oxide phase comprises a compound selected from the group consisting of: NiO, CoO, CuO, and any other reducible oxides.

5. The device of claim 4, wherein the metal oxide phase comprises nickel oxide.

6. The device of claim 1, wherein the substrate layer is in a reduced state wherein the metal oxide phase is reduced to metal, and wherein the metal oxide phase comprises nickel oxide.

7. The device of claim 1, wherein:
when in an unreduced state the volume of the metal oxide phase in the composite is sufficient to ensure that metal oxide grains are in contact in the ceramic proton conducting oxide phase, and
upon reduction of the metal oxide phase to the metallic state in a reducing atmosphere, a continuous and open porous network is formed throughout the substrate to allow diffusion of hydrogen gas from the interface of the hydrogen permeable layer and the substrate to the opposing surface.

8. The device of claim 1, wherein the hydrogen permeable layer is disposed over a first surface of the substrate layer, for example wherein the hydrogen permeable layer is disposed in direct contact with the substrate layer and in the absence of an intervening electrolyte layer.

9. The device of claim 1, wherein the device has a curved surface and/or is spherical.

10. The device of claim 1, wherein the substrate layer and the hydrogen permeable layer lack the presence of electrical connectors (e.g. wires or contact pad) to provide a bias potential between the layers.

11. A hydrogen separator comprising:
a fuel gas channel comprising a fuel gas containing hydrogen,
a product hydrogen reservoir containing product hydrogen, and
the layered device of claim 1,
wherein:
the layered device is disposed between and separates the fuel gas channel and the product hydrogen reservoir,
the hydrogen permeable layer is disposed facing the fuel gas channel,
the ceramic composite substrate layer is disposed facing the product hydrogen reservoir, and the partial pressure of hydrogen in the fuel gas channel is greater than the partial pressure of hydrogen in product hydrogen reservoir.

12. The hydrogen separator of claim 11, wherein the fuel gas channel comprises a mixture of gases selected from the group consisting of: H₂, CO, CO₂, H₂O, Ar, N₂, CH₄ and other low molecular weight hydrocarbons.

13. The hydrogen separator of claim 11, wherein the partial pressure of hydrogen in the fuel gas channel is between 1.1 and 50 times greater (for example between 1.5 and 40, between 2 and 30, or between 2 and 20 times greater) than the partial pressure of hydrogen in product hydrogen reservoir, for example wherein the partial pressure of hydrogen pressure of hydrogen in the product hydrogen reservoir is about 1 ATM (or less such as under vacuum) and the partial pressure of hydrogen in fuel gas channel is at least 1.5 ATM (for example 2 ATM, 3 ATM, 5 ATM, 10 ATM or more).

14. A pressure-driven hydrogen separation device comprising:
a layered device comprising a ceramic composite substrate layer comprising a metal oxide phase and ceramic proton conducting oxide phase, wherein the substrate layer is dense upon sintering and has contiguous porosity upon reduction in reducing atmosphere,
a fuel gas channel comprising a fuel gas containing hydrogen, and
a product hydrogen reservoir containing product hydrogen,
wherein:
the layered is disposed between and separates the fuel gas reservoir and the product hydrogen reservoir,
the partial pressure of hydrogen in the fuel gas channel is greater than the partial pressure of hydrogen in product hydrogen reservoir.

15. The device of claim 14, wherein:
the layered device further comprises a hydrogen permeable layer comprising a single metal, metal alloy or layers of different metals,
the ceramic composite substrate layer is disposed facing the product hydrogen reservoir, and
the hydrogen permeable layer is disposed facing the fuel gas channel.

16. The device of claim 14, wherein the ceramic proton conducting substrate layer comprises a perovskite ceramic proton conductor having the general composition
AB₍₁₋ₓ₎XₓO_{3-d},
wherein the A-site comprises Ba or Sr, the B-site comprises Zr and/or Ce and X comprises an aliovalent dopant cation consisting of Y, Yb, Eu, Gd, other rare earth elements or combinations thereof, and
wherein the metal oxide phase comprises a compound selected from the group consisting of: NiO, CoO, CuO, and any other reducible oxides, for example wherein the metal oxide phase comprises nickel oxide.

17. The device of claim 14, wherein the substrate layer is in a reduced state wherein the metal oxide phase is reduced to metal, and wherein the metal oxide phase comprises nickel oxide.

18. The device of claim 14, wherein when in an unreduced state the volume of the metal oxide phase in the composite is sufficient to ensure that metal oxide grains are in contact in the ceramic proton conducting oxide phase,
wherein upon reduction of the metal oxide phase to the metallic state in a reducing atmosphere, a continuous and open porous network is formed throughout the substrate to allow diffusion of hydrogen gas from the interface of the metal membrane and the substrate to the opposing surface.

19. The device of claim 14, wherein the hydrogen membrane layer is disposed over a first surface of the substrate layer, for example wherein the hydrogen membrane layer is disposed in contact with the substrate layer and in the absence of an intervening electrolyte layer.

20. The device of claim 14, wherein the substrate layer and the hydrogen permeable layer lack the presence of electrical connectors (e.g. wires or contact pad) to provide a bias potential between the layers.

21. A method for pressure-driven separation of hydrogen comprising the steps of:
I. providing the pressure-driven hydrogen separation device of claim 14,
II. flowing a fuel gas in the fuel gas channel,
III. allowing hydrogen to permeate across the ceramic composite substrate layer and into the product hydrogen reservoir,
wherein:
the partial pressure of hydrogen in the fuel gas channel is greater than the particle pressure of hydrogen in product hydrogen reservoir.

22. A method for forming a layered hydrogen separation device comprising the steps of:
I. forming a ceramic composite substrate layer comprising a metal oxide and ceramic proton conducting oxide,
II. sintering the substrate layer formed in step I,
III. reducing the sintered substrate layer formed in step II in a reducing atmosphere; and
IV. depositing a hydrogen diffusion membrane layer over a first surface of the substrate layer, wherein the hydrogen diffusion membrane layer contains a single metal, metal alloys or layers of different metals.

23. An arrayed hydrogen separation system comprising:
a plurality of pressure-driven hydrogen separation devices as described in claim 14,
a common product hydrogen channel, and
a common fuel gas channel,
wherein:
the plurality of devices are disposed in a planar radial array about the common product hydrogen channel,
the plurality of devices are each spherical and enclose their respective product hydrogen reservoir which are connected to and in fluid communication with the common hydrogen channel,
the common fuel gas channel is common to the plurality of devices.

24. A stacked arrayed hydrogen separation system comprising a plurality of arrayed hydrogen separation systems as described in claim 23, wherein:
the plurality of arrayed hydrogen generation systems are stacked axially about the common product hydrogen channel, and
the common product hydrogen channel and the common fuel gas channel are common to the plurality of arrayed hydrogen separation systems.
